(19) United States
(12) Patent Application Publication
(10) Pub. No.: US 2016/0023640 A1
(43) Pub. Date: Jan. 28, 2016

(54) WIRELESS, VOICE ACTIVATED FLUID EXCHANGE MACHINE

(71) Applicant: NORCO INDUSTRIES, INC., Compton, CA (US)

(72) Inventor: Frank Casale, Fishers, IN (US)

(21) Appl. No.: 14/878,911

(22) Filed: Oct. 8, 2015

Related U.S. Application Data
(63) Continuation-in-part of application No. 14/062,029, filed on Oct. 24, 2013.
(60) Provisional application No. 62/072,860, filed on Oct. 30, 2014.

(51) Int. Cl. B60S 5/02; B67D 7/04

(52) U.S. Cl. CPC B60S 5/02; B67D 7/04

(57) ABSTRACT

The present invention is directed to a fluid exchange machine for replacing fluid in a vehicle subsystem that can be controlled remotely using wireless technology to make fluid exchange operations easier, safer, and more convenient. The fluid exchange machine of the present invention operates within a number of different platforms and communication technologies to provide a wide array of options. Using smartphones, tablets, or other hand held devices, a technician can send instructions wirelessly to the machine to both operate the machine and retrieve important data from the machine. The communication in one preferred embodiment uses voice commands to instruct and control the machine, while other embodiments utilize more traditional data input can be utilized.

### CROSS-REFERENCES TO RELATED APPLICATIONS

This application is a continuation-in-part of U.S. patent application Ser. No. 14/062,029, filed Oct. 24, 2013, the contents of which are incorporated by reference herein, and further claims priority from U.S. application No. 62/072,860, filed Oct. 30, 2014 incorporated by reference in its entirety.

### BACKGROUND

There are a wide variety of fluid exchange machines that are used to service vehicles of every kind. Examples of fluid exchange machines include transmission fluid exchange or flush machines, power steering fluid exchange or flush machines, brake fluid exchange or flush machines, differential fluid exchange or flush machines, engine coolant exchange or flush machines, nitrogen generators, fluid extractors, diesel exhaust fluid filler and/or extractor, and the like. These machines typically extract used fluid from a vehicles sub-system such as a transmission system, braking system, coolant system, etc., and replace the used fluid with fresh fluid. This is done to maintain effectiveness of the system, protect the system from wear or overheating, ensure an adequate supply of the working fluid in the system, and comply with manufacturers recommended maintenance for the particular vehicle.

Fluid exchange machines vary in construction and operation, but may generally take the form of a fixed or mobile station that can be moved to the vehicle for the fluid exchange operation. The working components may be housed in a cabinet or enclosure to protect the sensitive components from dirt, exposure, moisture, and the like. The fluid exchange machine normally includes a source or supply of the fluid to be exchanged, in the form of a tank that may or may not be pressurized. For non-pressurized tanks, a pump is used to transfer the fluid from the tank to the vehicle's sub-system, such as the transmission brake lines. A hose or conduit connects the pump to the vehicle, and in many cases appropriate connectors, adapters, or fittings are used to create a fluid-tight seal with the pump. The pump and tank may be housed in the cabinet, with the hose or hoses adapted to mate with a port on the pump or tank using quick disconnect fittings. The service worker connects the fluid exchange machine to the vehicle via the hose, and fluid is delivered to the vehicle via the pressurized tank or by the pump.

In some cases, used fluid is extracted either before or during the fluid filling operation. That is, the particular vehicle subsystem's fluid is drained or vacuumed while or before the new fluid is introduced. To remove the fluid, in some cases the fluid is gravitationally removed by simply opening the system at a drain positioned at a low elevational position to allow gravity to drain the fluid into a collection device such as a pan, funnel, etc. In other systems, the fluid must be removed through negative pressure (vacuum) or positive pressure (blowing) to evacuate the system prior to introducing the fresh fluid. Fluid exchange machines designed for specific subsystems such as a vehicle's transmission system include the implements (pumps, fans, conduits, fittings, etc.) for both administering the fluid and evacuating and collecting and old fluids.

While vehicle fluid exchange machines have existed for many years, more recently the advent of smaller, faster, and cheaper computers have increased the complexity and sophistication of such machines. Control boards monitor the status of the fluid exchange operation and the condition of the machine itself, check pressures and fluid levels, record vehicle service information for service records, inventory fluid levels in the new and used fluid tanks, and perform a wide array of tracking and control functions for operation of the fluid exchange machine. Control boards include one or more microprocessors that are coupled to sensors and actuators to carry out the functions of the board. Sensors can include flow meters, pressure sensors, temperature sensors, fluid level sensors, capacitors that detect varying electrical conductivities or resistances, and a myriad of other types of sensors depending upon the fluid exchange operation. Actuators can include controllers for the pumps, buttons/knobs/keys for entering data and information, touch pads or screens for data input, valves for opening and closing fluid lines, solenoids for controlling the mechanical devices, and other actuators used in the fluid exchange operation.

While there have been advances in the sophistication and capability of such fluid exchange machines used to replace various fluids in a vehicle, a new generation of fluid exchange machines are being developed today that will improve both safety, convenience, and efficiency of the machines. The present invention is first in the line of such new generation machines.

### SUMMARY OF THE INVENTION

The present invention is directed to a fluid exchange machine for replacing fluid in a vehicle subsystem that can be controlled remotely using wireless technology to make fluid exchange operations easier, safer, and more convenient. The fluid exchange machine of the present invention operates within a number of different platforms and communication technologies to provide a wide array of options. Using smartphones, tablets, or other hand held devices, a technician can send instructions wirelessly to the machine to both operate the machine and retrieve important data from the machine. The communication in one preferred embodiment uses voice commands to instruct and control the machine, while other embodiments utilize more traditional data input can be utilized. The smart phone, tablet, or other hand held device could monitor a plurality of fluid exchange machines, determine the number of fluid exchange operations, and conduct other inventory and statistical operations to facilitate the continued operation of the machines.

One byproduct of the use of remote access to the fluid exchange machines is the ability to monitor off site machines and their usage. Many of fluid exchange machines are purchased by companies who sell the automotive fluids, such as transmission fluid or brake fluid. In many cases, the companies then provide these machines to service stations, repair shops, and other vehicle maintenance businesses at a reduced price under an agreement that the service station will only purchase the replacement fluids from them. The service stations get a free or reduced price fluid exchange machine, and the fluid supplier has a customer who is obligated to purchase its product exclusively.

The problem that arises, however, is that the fluid supplier has no way of verifying that the service station is using the supplier's products exclusively. Many times a service station will begin to use cheaper oils or fluids, and under-report the number of services that it is performing. Alternatively, the service station can move the fluid exchange machine offsite and perform the fluid exchanges at a location unknown to the fluid supplier, preventing monitoring. The fluid supplier is helpless to prevent this type of fraud without access to the service station's facilities. However, with the ability to remotely connect to the fluid exchange machines with a smart phone or the like, the number of fluid exchanges can be interrogated by the remote wireless device and the fluid supplier can verify that the terms of the agreement are being met by the service provider.

The present invention can be characterized generally as a fluid exchange machine, such as a brake fluid exchange machine or an automatic transmission fluid exchange machine, coolant, power steering, transmission differential, or the like, that includes a new fluid tank, a waste fluid tank or collector, a pump for introducing new fluid into a vehicle, and a controller for managing the operation of the fluid exchange machine. Coupled to the controller is a wireless transmitter/receiver that can communicate with a hand held device through one of several protocols to control and monitor the operation of the fluid exchange machine. In a preferred embodiment, the wireless transmitter/receiver can track and communicate the number and time of each fluid exchange operation, and send the information to the remotely connected hand-held device so the recipient of the data can discern how many fluid exchange operations the machine has performed since a precious check, and when each fluid exchange operation is performed. The machine may also report wirelessly to the smart phone or tablet any diagnostic or maintenance issues relevant to the machine's operation. With this information, compliance with existing agreements can be assured.

### BRIEF DESCRIPTION OF THE DRAWINGS

FIG. 1 is an elevated perspective view of an exemplary fluid exchange machine;

FIG. 2 is a schematic diagram of a controller and transmitter of the fluid exchange machine of FIG. 1;

FIG. 3 is a schematic diagram of a controller communicating with a tablet or smart phone;

FIG. 4 is a screen shot of a sample display shown in a tablet or smart phone, showing data from the fluid exchange machine; and

FIG. 5 is another screen shot of a sample display shown in a tablet or smart phone, showing data from the fluid exchange machine.

### DETAILED DESCRIPTION OF THE PREFERRED EMBODIMENTS

The fluid exchange machine of the present invention may work with one or more of a variety of known short range or long range communication protocols. A few of the possible protocols are described briefly below.

Close range communication, or Personal Area Network (“PAN”), includes Bluetooth wireless communications that can be used to communicate between a tablet or smart phone (hereafter “smartphone” for brevity) to exchange data and commands with the fluid exchange machine. Bluetooth technology exchanges data over short distances using radio transmissions, and operates in the unlicensed industrial, scientific and medical (ISM) band at 2.4 to 2.485 GHz, using a spread spectrum, frequency hopping, full-duplex signal at a nominal rate of 1600 hops/sec. Bluetooth wireless technology has gained acceptance in many new devices and is a part of most smartphones sold today in the United States. Bluetooth technology sends information within a Personal Area Network at distances up to 100 meters (328 feet)—depending upon device implementation. To implement a Bluetooth communication link, the fluid exchange machine would include in the control board or in another component of the machine a small computer chip containing the Bluetooth radio, and the requisite software to connect, via Bluetooth wireless technology, to the smart phone.

Near field communication, or “NFC,” is also a rapidly growing standard communication protocol in all new smart phones. NFC is a form of short-range wireless communication where the antenna used is much smaller than the wavelength of the carrier signal (thus preventing a standing wave from developing within the antenna). In the near-field, the antenna can produce either an electric field, or a magnetic field, but not an electomagnetic field. Thus NFC communicates either by a modulated electric field, or a modulated magnetic field, but not by radio (electromagnetic waves). For example, a small loop antenna produces a magnetic field, which can then be picked up by another small loop antenna, if it is in close enough proximity with the sending loop. Magnetic NFC has a useful property of being able to penetrate conductors that would reflect radio waves.

Many of today's smart phones use electric-field NFC (operating at a frequency of 13.56 MHz, corresponding to a wavelength of 22.11 m) for certain special transactions because the very short range of NFC makes it difficult to intercept. To efficiently generate a far-field, which means to send out radio waves of this wavelength, one typically needs an antenna of a quarter wavelength, in practice a meter or more. If the antenna is just a few centimeters long, it will only set up the ‘near-field’ around itself, with length, width and depth of the field roughly the same as the dimensions of the antenna. Very little energy is radiated away, it is essentially a stationary electromagnetic field pulsating at 13.56 MHz. If another similarly small antenna comes into this field, it will induce an electric potential into it, alternating at the same frequency. By modulating the signal in the active antenna, one can transmit a signal to the passive, receiving antenna. Communication is also possible between an NFC device and an unpowered NFC chip, called a “tag”. Thus, the fluid exchange machine is equipped with either a NFC antenna or tag, and the connected smart phone can wirelessly communicate with the machine and send and receive data and commands over the NFC PAN network.

A third option for quick and reliable data communication and exchange is via a USB cable or “firewire.” Although not wireless, the USB cable permits rapid communication with a smartphone across a secure platform. Virtually all later model smartphones have a data port that uses either a USB cable, a firewire cable, or some proprietary datalink to allow data to be extracted and received by a smartphone. The present invention includes a plurality of data ports that can connect directly to a smartphone via the designated cable to permit direct exchange of data and commands between the fluid exchange machine and the smartphone.

For communications across medium distances, a local area network (“LAN”) can be used. For example, at distances of one hundred to three hundred feet, a wifi connection is one option for establishing communication between the fluid exchange machine and the smartphone. Wifi is a wireless networking technology that uses radio waves to provide wireless high-speed Internet and network connections. Wi-Fi is a trademarked designation for communications that use IEEE 802.11x protocols. Wi-Fi is commonly used to refer to any wireless local area network (WLAN) products that are based on the Institute of Electrical and Electronics Engineers' (IEEE) 802.11 standards. Initially, Wi-Fi was used in place of only the 2.4 GHz 802.11b standard, however it has expanded to include any type of network or WLAN product based on any of the 802.11 standards, including 802.11b, 802.11a, dual-band, etc.

Wi-Fi works wirelessly between a sender and a receiver by using radio frequency (RF) technology, a frequency within the electromagnetic spectrum associated with radio wave propagation. When an RF current is supplied to an antenna, an electromagnetic field is created that then is able to propagate through space. The cornerstone of any wireless network is an access point (AP). The primary job of an access point is to broadcast a wireless signal that a processor can detect and “tune” into. In order to connect to an access point and join a wireless network, computers and smart phones must be equipped with wireless network adapters. Both the fluid exchange machine and the smartphone controlling the fluid exchange machine are equipped with such network adapters.

For long range communications, a cellular network would be the preferred protocol between the smartphone and the fluid exchange machine. This is convenient, since the smartphone is already equipped with such technology, and the incorporation of a Wide Area Network (“WAN”) or other far field communication systems are readily adaptable to the present invention. A cellular network or mobile network is a wireless network distributed over land areas called cells, each served by at least one fixed-location transceiver, known as a cell site or base station. In a cellular network, each cell uses a different set of frequencies from neighboring cells, to avoid interference and provide guaranteed bandwidth within each cell. When joined together the cells provide radio coverage over a wide geographic area. This enables a large number of portable transceivers (e.g., mobile phones, pagers, etc.) to communicate with each other and with fixed transceivers and telephones anywhere in the network, via base stations, even if some of the transceivers are moving through more than one cell during transmission.

Cellular networks offer a number of desirable features. Cellular communication provide more capacity than a single large transmitter, since the same frequency can be used for multiple links as long as they are in different cells. Mobile devices also use less power than with a single transmitter or satellite since the cell towers are closer, and larger coverage areas than a single terrestrial transmitter are possible, since additional cell towers can be added indefinitely and are not limited by the horizon. Major telecommunications providers have deployed voice and data cellular networks over most of the inhabited land area of the Earth. This allows mobile phones and mobile computing devices to be connected to the public switched telephone network and public Internet.

To communicate with the fluid exchange machine, one option would be to use voice controlled commands. Voice recognition is “the technology by which sounds, words or phrases spoken by humans are converted into electrical signals, and these signals are transformed into coding patterns to which meaning has been assigned.” The difficulty in using voice as an input to a computer processor lies in the fundamental differences between human speech and the more traditional forms of computer input. While computer programs are commonly designed to produce a precise and well-defined response upon receiving the proper (and equally precise) input, the human voice and spoken words are anything but precise. Each human voice is different, and identical words can have different meanings if spoken with different inflections or in different contexts.

The most common approaches to voice recognition can be divided into two classes: “template matching” and “feature analysis”. Template matching is the simplest technique and has the highest accuracy when used properly, but it also suffers from the most limitations. As with any approach to voice recognition, the first step is for the user to speak a word or phrase into a microphone. The electrical signal from the microphone is digitized by an “analog-to-digital (A/D) converter”, and is stored in memory. To determine the “meaning” of this voice input, the computer attempts to match the input with a digitized voice sample, or template, that has a known meaning. This technique is a close analogy to the traditional command inputs from a keyboard. The program contains the input template, and attempts to match this template with the actual input using a simple conditional statement.

Since each person's voice is different, the program cannot possibly contain a template for each potential user, so the program must first be “trained” with a new user's voice input before that user's voice can be recognized by the program. During a training session, the program displays a printed word or phrase, and the user speaks that word or phrase several times into a microphone. The program computes a statistical average of the multiple samples of the same word and stores the averaged sample as a template in a program data structure. With this approach to voice recognition, the program has a “vocabulary” that is limited to the words or phrases used in the training session, and its user base is also limited to those users who have trained the program. This type of system is known as “speaker dependent.” It can have vocabularies on the order of a few hundred words and short phrases, and recognition accuracy can be about 98 percent. For the present invention, where commands are limited, this is a reasonable option since there would be only a limited vocabulary needed to achieve virtually all of the required commands and inputs.

A more general form of voice recognition is available through feature analysis and this technique usually leads to “speaker-independent” voice recognition. Instead of trying to find an exact or near-exact match between the actual voice input and a previously stored voice template, this method first processes the voice input using “Fourier transforms” or “linear predictive coding (LPC)”, then attempts to find characteristic similarities between the expected inputs and the actual digitized voice input. These similarities will be present for a wide range of speakers, and so the system need not be trained by each new user. The types of speech differences that the speaker-independent method can deal with, but which pattern matching would fail to handle, include accents, and varying speed of delivery, pitch, volume, and inflection.

Improvements in these voice recognition systems have paved the way for human to machine commands to be voice implemented. The present invention incorporates voice recognition software that allows a user to audibly command the fluid exchange machine to perform operations, send data, check statuses, and conduct other functions in response to the voice commands.

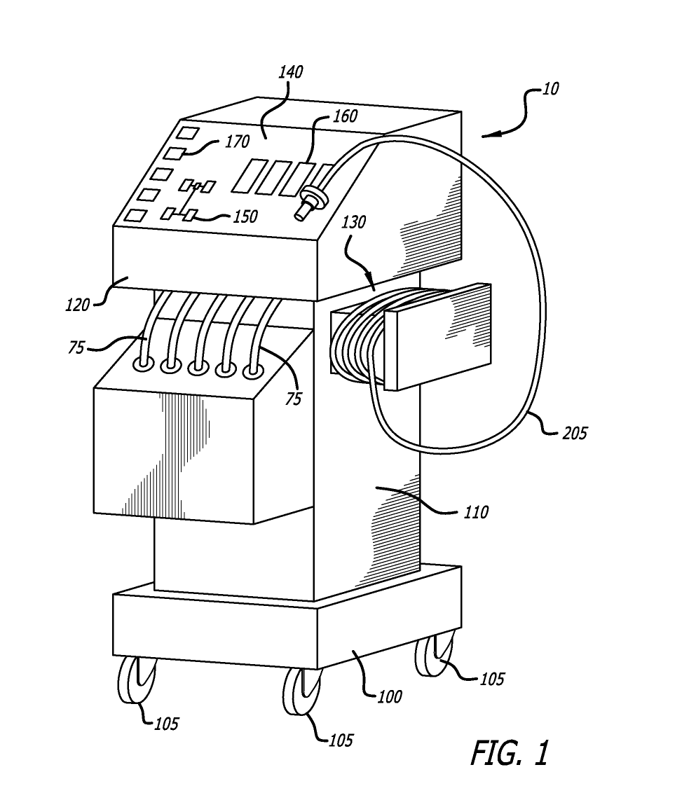

Turning to the fluid exchange machines themselves, there are a number of commercial automotive fluid exchange machines on the market, and the details of the fluid exchange machine are not essential to the understanding of the present invention. Examples of fluid exchange machines can be found, e.g., in U.S. Pat. Nos. 6,035,903, 5,626,170, 8,104,522, 7,597,121, 6,959,740, 6,877,531, and 6,772,802, the contents of each of which are fully incorporated herein by reference. The operation of the fluid exchange machine will be described only basically herein using the schematic of FIG. 1.

FIG. 1 depicts a fluid exchange machine 10, such as a brake fluid exchange machine, which is used to withdraw used fluid from a vehicles hydraulic brake system and replenish the brake system with clean, fresh brake fluid. It is to be understood that the present invention is not intended to be limited to a brake fluid exchange machine, but rather applies to all vehicle fluid replacement machines such as brake, transmission, power steering, oil, and the like. The fluid exchange machine 10 is a combination of plumbing components (pumps, tubing, valves) and electrical components (processors, electrical cables, display equipment) enclosed in a durable plastic housing 110. The housing 110 includes a platform 100 with four caster wheels 105 that allow the fluid exchange machine 10 to be rolled quickly into position as needed to service the vehicle. Other embodiments, both fixed and mobile, are considered within the scope of the present invention, and it is not limited to any particular cabinet, mobility, or shape. In the housing of the example machine is a twenty quart waste fluid tank 18, a seven quart new fluid tank 16, an electrical system powered by a twelve volt battery such as those found in most passenger vehicles, a vacuum pump 32, and a pressure pump 22. Some machines use another type of collector for the used fluid, and the invention is not limited to used fluid tanks. Further, the machine may be powered by other means, such as a wall mounted AC current.

The housing 110 includes a podium-like structure 120 having a column 130 and display/control panel 140. The controls for operating the machine and the sight glasses to evaluate the progress of the fluid exchange process are located on the display/control panel area 140. The display may include, for example, a face plate with an illuminated status diagram 150 to track the progress of the fluid exchange operation, five separate sight glasses 160 to visually check the transformation of the used fluid to fresh fluid, and buttons 170 for operating the machine manually rather than automatically. Said buttons 170 include a master cylinder pressure button for detecting leaks around the master cylinder cap, an anti-lock brake cylinder button for removing brake fluid from the ABS reservoir, a forward axel start button for initiating withdrawal of the used fluid from the front brake axel cylinders, and rearward axel start button for initiating withdrawal of the used fluid from the rear brake cylinders. An “add fluid/drain new tank” button activates the pressure pump to force new fluid from the new fluid tank, which could be used to top off the system or to evacuate the new fluid tank. A “remove fluid” button actuates the vacuum pump 32 to withdraw fluid through any of the attached fluid lines. A “drain waste tank” button can be used to evacuate the used fluid tank in the machine, and a “prime” button is used to prime the pumps 22, 32 for operation. Finally, an oversized “stop” button terminates the operation of the machine. Other controls may be present depending upon the subsystem serviced, the type of fluid, and the type of fluid exchange operation.

A schematic 150 of the vehicle brake system may be included on the control area 140 overlaying LED lights that show the cylinder being drained during the fluid exchange operation. That is, the rear passenger cylinder LED illuminates as that cylinder is evacuated, and then the rear driver cylinder LED illuminates and so on. Information/Warning LED lights also are found on the control area 140, including an indicator for the ABS fluid exchange, a warning light when the waste tank is full, a warning when the new fluid tank is empty, and an indicator light showing the machine is operation. In addition, a separate sight glass 160 is provided for each fluid line connecting the vacuum pump 32 to the rear passenger wheel, the rear driver wheel, the front passenger wheel, the front driver wheel, and the ABS system. As the fluid exchange process proceeds, the fluid is pumped through the sight glass for visual inspection. The fluid in the sight glass will initially reflect the dark, murky color reflecting the oxidized used fluid and then gradually change to a reddish clearer color indicative of new, unoxidized brake fluid. Beneath the control area 140 is a controller 20 in the form of a circuit board coupled to a microprocessor for controlling the operation of the fluid exchange machine, including pressure sensitive switches beneath the buttons on the control area that translate the user's physical depressing of the buttons into commands for the controller 20. The housing 110 may also include five lines 75 of approximately fifteen feet that allow the machine to connect with the four bleeder valves of the respective wheel cylinders and the ABS system if present, along with hoses 205 that connect the fluid exchange machine 10 with a vehicle 24.

In the present invention, the fluid exchange machine 10 is equipped with a special communication unit 300 that is connected to the controller 20 of the fluid exchange machine 10 via cable 305 or other coupling (hardwired or wireless) for exchanging data and commands with the controller 20. As explained in more detail below, the communication unit 300 can monitor the status of the fluid exchange machine through the controller 20, including the status of various circuits or sensors depending upon the needs of the system, and communicate the status and conditions of the machine to a remote smartphone or the like. The communication unit 300 can also receive commands wirelessly from a connected handheld unit such as a smart phone or tablet, and carry out the commands via the connected controller 20. Commands can include starting the machine, stopping the machine, running diagnostics on the machine, checking the fluid levels in the tanks, and the like.

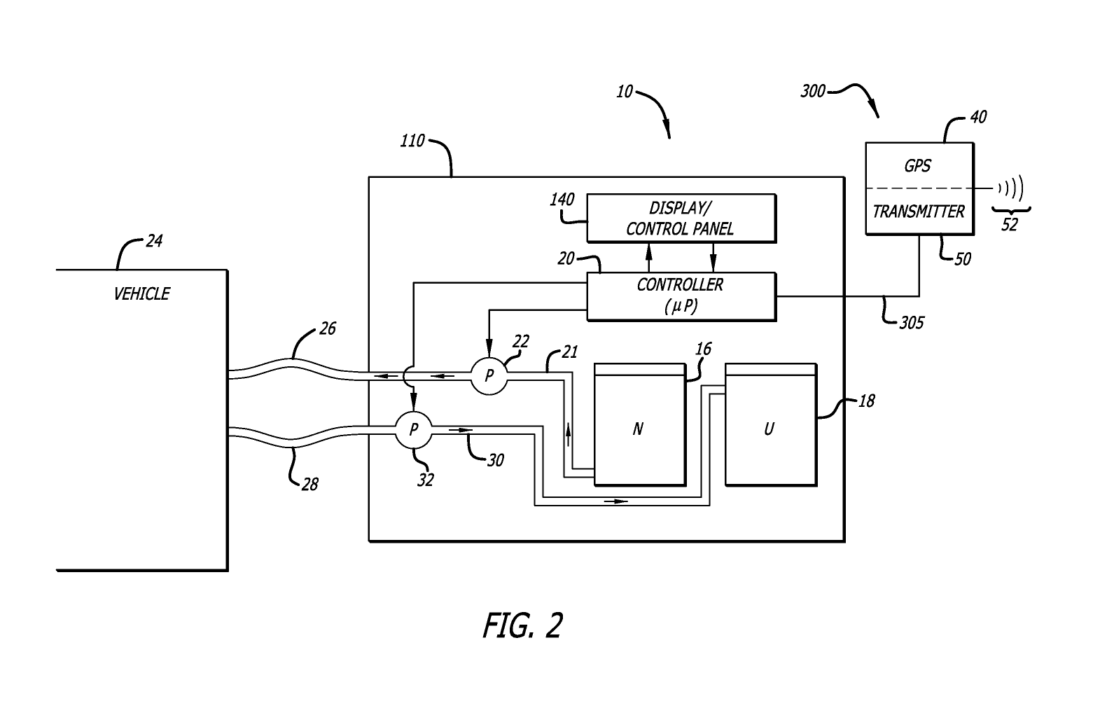

FIG. 2 is a generic schematic of a more general fluid exchange machine 10 and its plumbing connections. A new fluid tank 16 within the housing 110 is connected by a fluid conduit 21 to the pressure pump 22, which forces fresh vehicle replacement fluid from the new fluid tank 16 to the vehicle to be serviced through hose 26. In the case of a brake fluid replacement machine, a pressure sensor (not shown) measures the fluid pressure in the master cylinder of the vehicle 24 and communicates the pressure to the microprocessor of the controller 20. On the used fluid side f the system, the vehicle's hydraulic system is connected to the vacuum pump 32 through hose 28 and fluid conduit 30. In the case of a brake fluid replacement machine, single conduit 30 could be replaced with a multi-valve solenoid (not shown) that connects to respective cylinders of the vehicle's brake system or the ABS reservoir if present. The controller 20 of the fluid exchange machine 10 controls the vacuum pump 32 and, if present, the opening and closing of the manifold by actuating the solenoid, which controls the sequence of the fluid withdrawal from the brake system. The vacuum pump 32 evacuates the used fluid to the used fluid tank 18 in the brake machine housing 110 via fluid conduit 30.

First, the new fluid tank 16 is filled with fresh brake fluid and the used fluid tank 18 is drained of any existing used fluid from a previous fluid exchange operation. Suction hose 28 is connected to the vehicle 24, and after depressing the “remove fluid” button on the control panel 140 the used fluid in the vehicle is substantially removed. The “stop” button is used to terminate the draining process. The fluid hose 26 is then connected to the vehicle 24 using an appropriate adapter. With the machine connected to the vehicle, the user depresses the “start” button, whereupon the machine will automatically begin pumping new fluid from the new fluid tank 16 through hose 26 and into the vehicle's hydraulic system. Once the fluid exchange is complete, the hoses are disconnected and adjustments to the fluid level, either removing or adding fluid, can be completed using the appropriate buttons.

In some fluid exchange machines, the used fluid is withdrawn from the vehicle with a vacuum pump 32, while other systems rely on the vehicle's own pumping system to evacuate the used fluid. The controller 20 controls the pumps 22,32, and concludes the operation when the new fluid in the vehicle 24 has replaced the used fluid. The details of other exemplary fluid exchange machines are found in the specifications of the patents cited above and incorporated herein by reference.

In the present invention, the communication unit 300 is connected to the controller 20 of a fluid exchange machine 10, where the communication unit 300 includes a wireless transmitter/receiver for exchanging electronic signals with a remote user via a smartphone. The communication unit can be included on the same circuit board as the controller 20, or it may be a separate module connected by a cable or wirelessly to the controller 20. The communication unit 300 includes a voice recognition software module that can interpret voice commands from the remote user and translate the voice commands into machine language to implement the instructions from the user. That is, the user may instruct the fluid exchange machine to initiate a fluid exchange sequence using, for example, the command “BEGIN.” The voice module on the communication device receives the audio signal from the user, and using the voice recognition software recognizes the signal to be a command to start the fluid exchange operation and sends a signal to the controller 20 to initiate the fluid exchange sequence stored in the memory of the controller. In this manner, the fluid exchange machine can be controlled remotely by a remote user. If the fluid exchange machine 10 includes a security code option, then it may be possible to limit the control of the machine to only those operators with permission to do so. The code can be entered audibly or via a keypad on the smartphone or tablet. This can be implemented to prevent unauthorized fluid exchanges and to monitor all uses of the fluid exchange machine remotely using a smartphone.

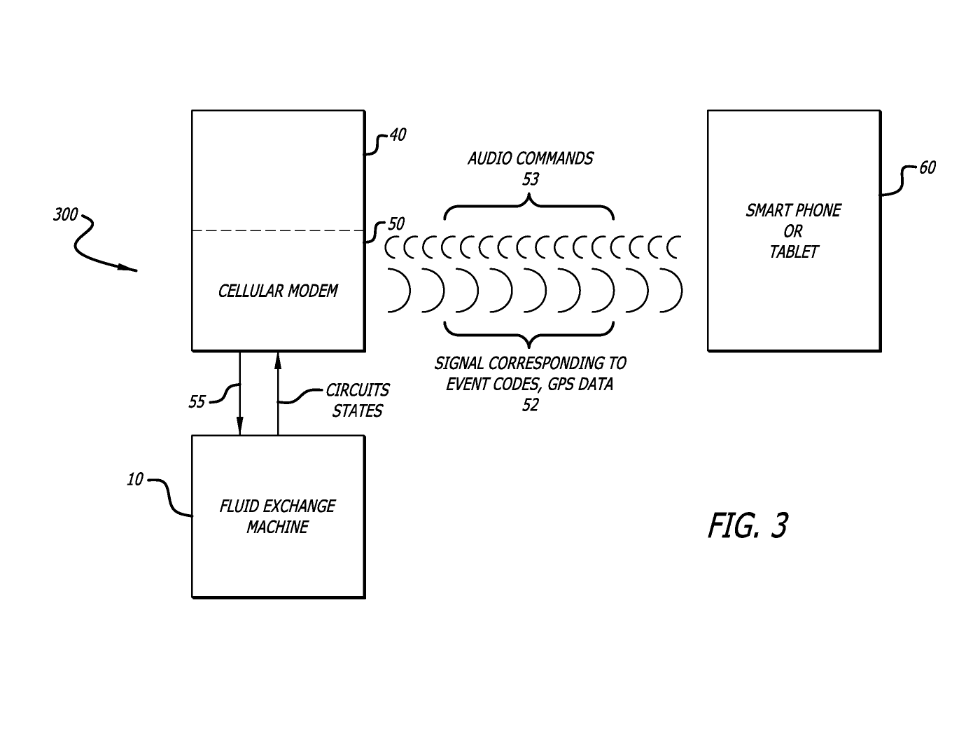

The communication unit 300 can be short range, medium range, or long range depending upon the intended use, or a combination thereof. The communication unit 300 can also send a signal or alert to the smart phone everytime a fluid exchange operation is initiated, allowing the fluid supplier to monitor when the fluid machine 10 is used. The communication unit 300 in a preferred embodiment, can monitor the state of certain selected circuits within the fluid exchange machine 10, such as the Power on/off switch, the initiate pump circuit, or the like. The communication 300 unit then employs a wireless link (FIG. 3) with the user's smartphone 60 via a cellular network (or other communication link), and sends wireless cellular signals 52 corresponding to event codes to a the smart phone 60 based on the state of the selected circuits. The smartphone may be loaded with an application, or “app,” that is software driven and interprets the signals 52 from the communication unit 300, and is capable of processing the event codes embedded in the cellular signals 52 into relevant management data. For example, data can include the number of times a machine is powered up for a service operation, and the date/time of each service operation. Depending upon the type of machine and the requirements of the data user, various other conditions and states of the fluid exchange machine can be monitored and stored.

Similarly, the smart phone or tablet 60 can send audio commands 53 to the communication unit 300, which are then transferred to the fluid exchange machine 10 via data packets 55. These data packets 55 are received by the controller 20, which translates the data packets into fluid exchange machine commands such as “begin,” “query,” “status,” “abort,” and the like. The fluid exchange machine interprets these commands and implements the commands as if entered manually on the control area 140. In this manner, the fluid exchange machine can be operated without the need for manual data entry, which can lead to input errors and other issues.

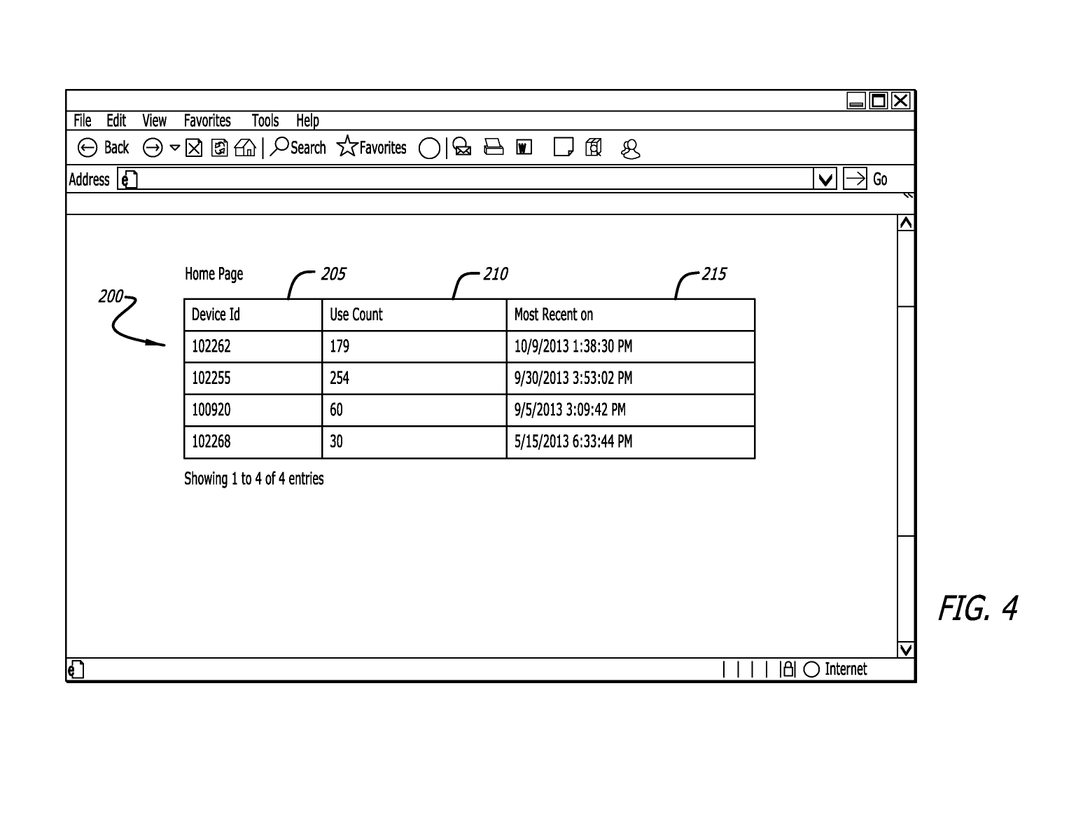

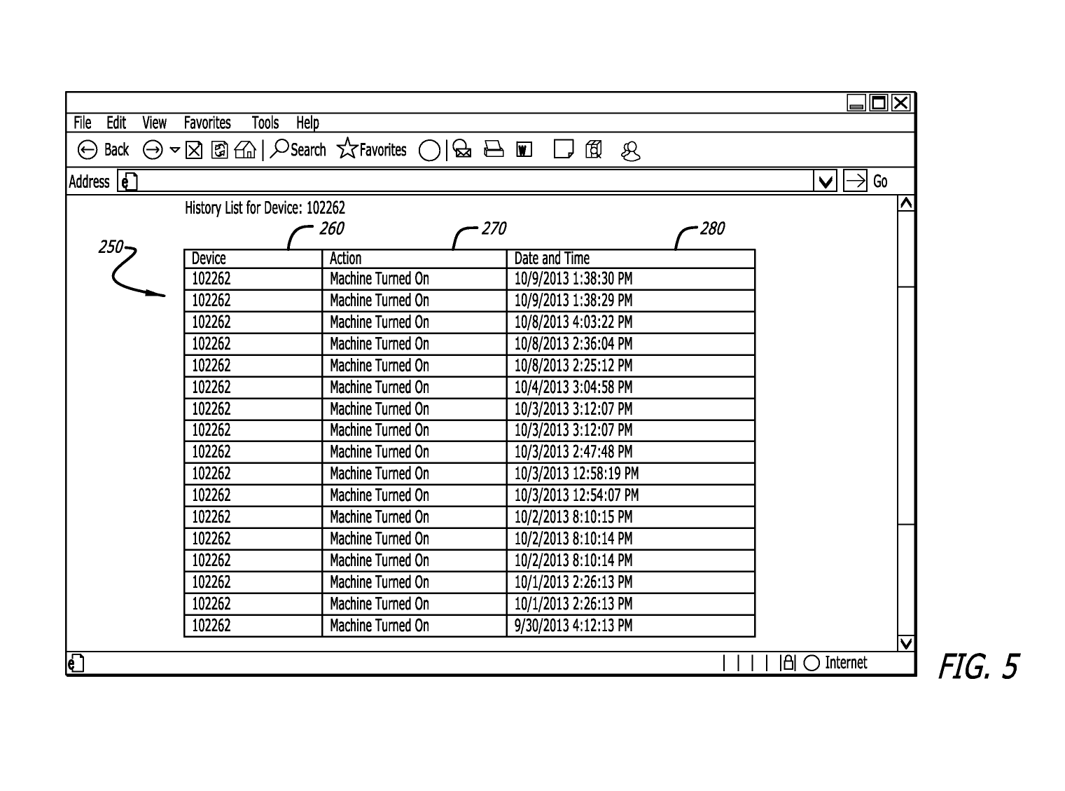

FIG. 4 illustrates a graphic user interface for an app on a smartphone that can be used to easily communicate with and monitor a plurality of fluid exchange machines registered with the app. The app is set up so that the fluid exchange machines can transmit data directly to the smartphone, and the user can access the information by simply activating the app. The app may include a signal that indicates new information is available, or a confirmation that a particular requested operation or activity has been completed. At a glance, the user can determine the amount of fluid exchange operations for each machine as well as the most recent use for each machine in the registry. From this app, each machine can be investigated further with touchscreen interface, or the like. For example, a table may be created by the graphic user interface of the app, showing a column listing the machine's identification 260, a column for the type of activity 270, and a time and date column 280 for the time and date that the activity occurred (FIG. 5). Using this graphic user interface on the app, the activity for each machine can be monitored to determine the frequency and type of use for each machine. Moreover, information can also be added such as the amount of new fluid used or the duration of each use to more accurately assess the usage of the machine.

While the present invention has been described using various exemplary embodiments, it is to be understood that many modifications are possible with the invention, and the invention should not be limited by the various described embodiments. Other types of vehicle fluid exchange machines are within the scope of the invention, and it is intended that the present invention cover all such modifications and other embodiments. Accordingly, the scope of the present invention is properly measured by the appended claims, using their plain and ordinary meanings, without limitation to the figures and descriptions set forth above.

I Claim:

1. A vehicle fluid exchange machine comprising:
a housing;
a new fluid storage tank;
a used fluid storage collector;
a user-actuated display panel;
a controller coupled to the control panel;
a pump coupled to the controller, and in fluid communication with the new fluid storage tank;
a first conduit for delivering the new fluid from the fluid exchange machine to the vehicle;
a second conduit for conveying used fluid from the vehicle to the used fluid storage collector; and
a communication unit for sending and receiving signals from a remote device, the communication unit sending data about the vehicle fluid exchange machine to the remote device and receiving voice commands from the remote device; and
a voice translator for receiving voice commands from the communication unit and translating the voice commands to machine language that can be interpreted by the controller for operating the vehicle fluid exchange machine.

2. The vehicle fluid exchange machine of claim 1, wherein the communication unit and remote device exchange operation data from the controller, and wirelessly transmits the fluid exchange operation data to the remote device.

3. The vehicle fluid exchange machine of claim 1, wherein the voice translator uses a speaker-independent voice recognition system.

4. The vehicle fluid exchange machine of claim 1, wherein the voice translator uses a template matching voice recognition system.

5. The vehicle fluid exchange machine of claim 2, wherein the voice recognition system transfers commands through a web site.
